(19) United States
(12) Patent Application Publication
(10) Pub. No.: US 2018/0040070 A1
(43) Pub. Date: Feb. 8, 2018

(54) METHOD OF GRADUATION ACCOUNT MANAGEMENT

(71) Applicant: Ulerick Fields, Houston, TX (US)

(72) Inventor: Ulerick Fields, Houston, TX (US)

(21) Appl. No.: 15/669,858

(22) Filed: Aug. 4, 2017

Related U.S. Application Data
(60) Provisional application No. 62/371,124, filed on Aug. 4, 2016.

(51) Int. Cl. G06Q 40/06

(52) U.S. Cl. CPC G06Q 40/06

(57) ABSTRACT

A method of increasing account management efficiency comprising the steps of first creating an account, wherein the account is held by a financial institution. Then, establishing a triggering event, wherein the triggering event consists of a graduation date of a predetermined user. Then, distributing the contents of the account based upon the trigger event, wherein the distribution occurs after the triggering event.

### CROSS-REFERENCE TO RELATED APPLICATION(S)

Not applicable

### BACKGROUND OF THE INVENTION

### 1. Field of Invention

The invention generally relates to a method and system for an account. More particularly, the invention relates to a method and system for a graduation bond for students of all ages payable upon graduation as a reward that gain market interest % from the bond company.

### 2. Description of Related Art

In finance, a bond is an instrument of indebtedness of the bond issuer to the holders. It is a debt security, under which the issuer owes the holder a debt and, depending on the terms of the bond, is obliged to pay them interest (the coupon) and/or to repay the principal at a later date, termed the maturity date. The traditional way others come close to the present invention is a college saving program or parents opening up a saving account for the child. It is therefore an object of the present invention to introduce a method and system for a graduation bond for students of all ages payable upon graduation as a reward that gains market interest % from the bond company.

Further, triggering events for bond maturity are generally predetermined due to time or value of the bond. This fails to provide security against a spendthrift situation whereby the beneficiary of the bond is generally capable of cashing a bond at their discretion. A lack of interconnectivity and communication between the financial institution and the bond/bond holder directly results in such failed attempts at protecting the initial intent of the investment.

Based on the foregoing, there is a need in the art for a method and system by which triggering events can relay information to a financial institution for a more efficient and automated process of bond maturity.

### SUMMARY OF THE INVENTION

A method of increasing account management efficiency comprising the steps of first creating an account, wherein the account is held by a financial institution. Then, establishing a triggering event, wherein the triggering event consists of a graduation date of a predetermined user. Then, distributing the contents of the account based upon the trigger event, wherein the distribution occurs after the triggering event.

In an embodiment, the method further comprises the step of associating one or more projected dates corresponding to the triggering event, wherein the one or more projected dates are predetermined based on a projected graduation date.

In an embodiment, the account is in communication with a database, wherein the database submits one or more inquiries across one or more networks, wherein the one or more inquiries are based upon the one or more projected dates, and wherein the one or more inquiries are transmitted to a remote server at the user's educational institution.

In an embodiment, the remote database receives the one or more inquiries and cross references the one or more inquiries with an actual graduation date, wherein the actual graduation date is maintained within the remote database.

In an embodiment, the remote database further cross references the one or more inquiries against a list of graduates, wherein if the user is found on the list of graduates, the triggering event occurs.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a schematic view of the method of graduation account management, according to an embodiment of the present invention;

FIG. 2 is a schematic view of the method of graduation account management, according to an embodiment of the present invention;

FIG. 3 is a schematic view of the method of graduation account management, according to an embodiment of the present invention;

FIG. 4 is a schematic view of the method of graduation account management, according to an embodiment of the present invention;

FIG. 5 is a schematic view of the method of graduation account management, according to an embodiment of the present invention;

FIG. 6 is a schematic view of the method of graduation account management, according to an embodiment of the present invention; and

FIG. 7 is a schematic view of the method of graduation account management, according to an embodiment of the present invention.

### DETAILED DESCRIPTION OF PREFERRED EMBODIMENTS

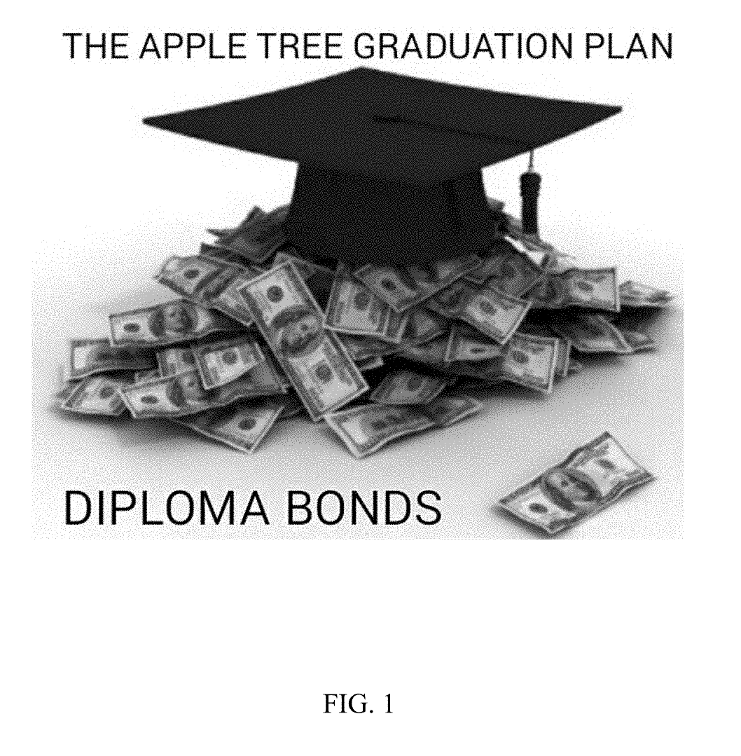

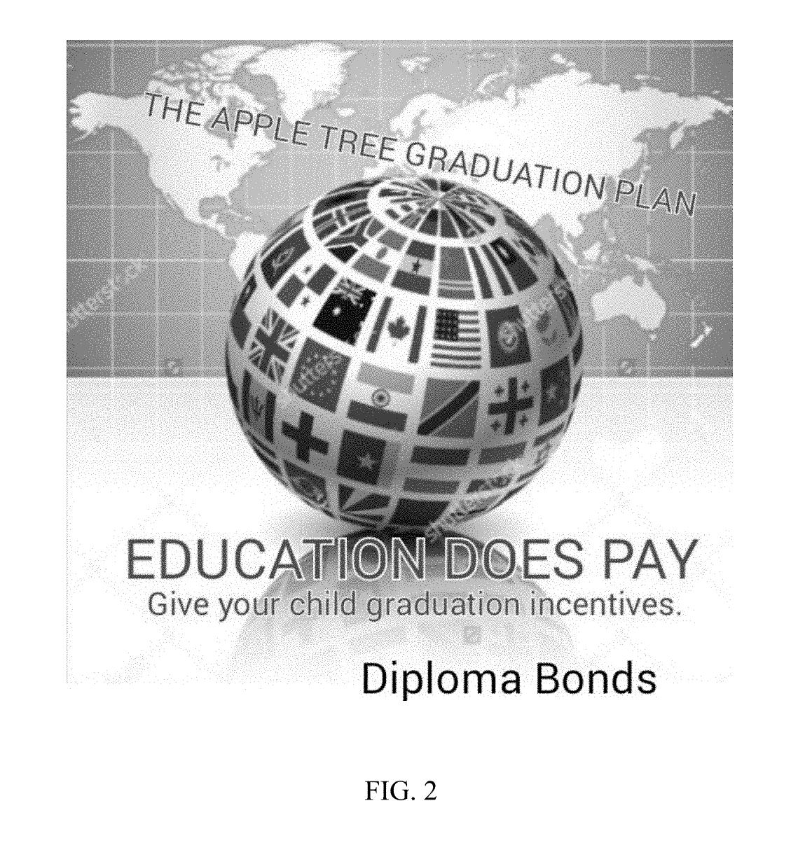

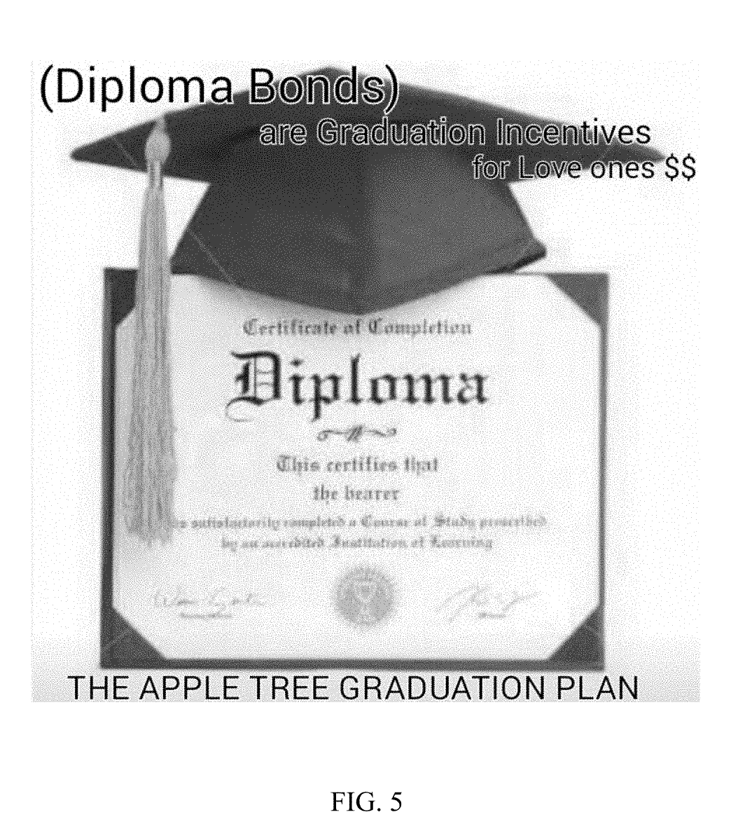

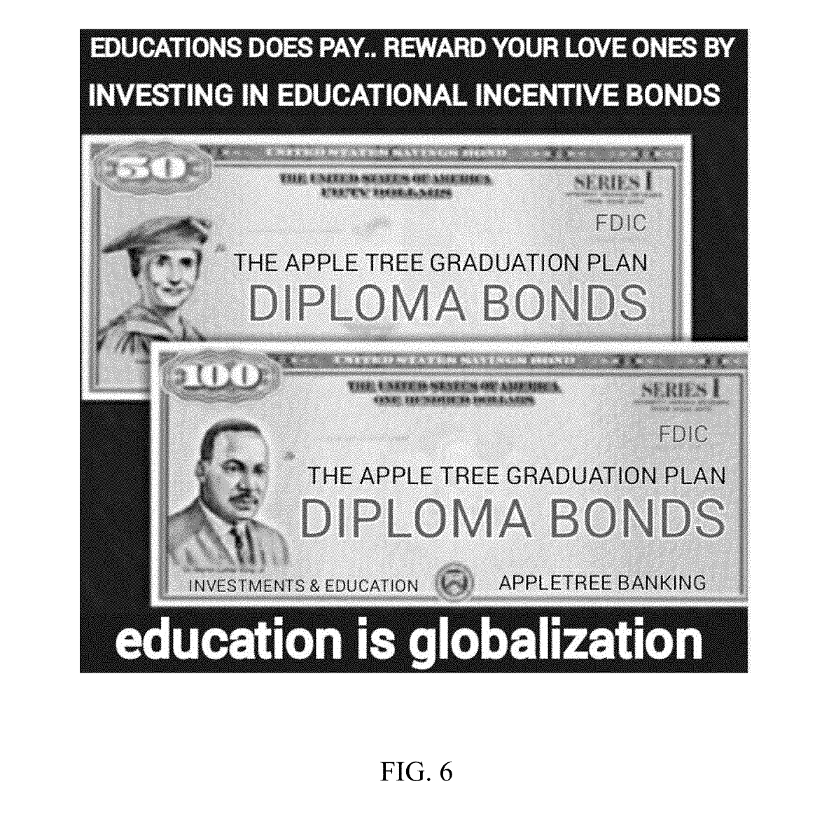

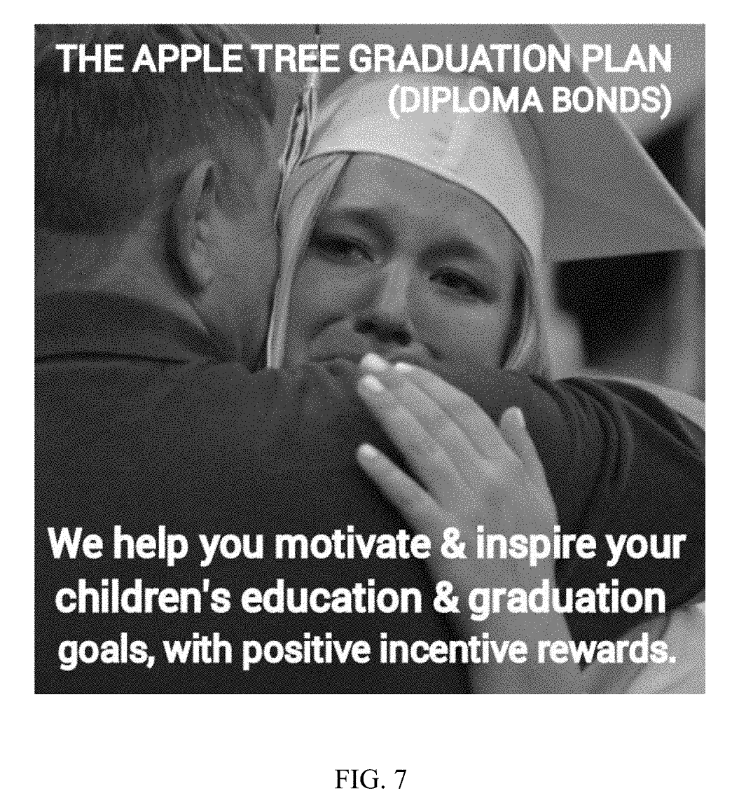

Preferred embodiments of the present invention and their advantages may be understood by referring to FIGS. 1-7.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

The present invention is a method and system for a graduation bond. It gives the parent a way to transform a basic savings account for their child into an Educational Bond account that gains interest % and pays out at the date of graduation, with proof of diploma. Anyone of legal age, parent/anyone can purchase a Diploma Bond for a student of their “Educational Diploma” grade school or higher learning at the buyer's request (Commercial, Corporate & Convertible Bonds).

THE APPLETREE GRADUATION PLAN (DIPLOMA BONDS) financial investment invention is a new educational graduation incentive method to reward graduate students upon completion of education. It gives investors/buyers a way to form or transform basic long-term & short-term educational goals into an investment policy for the student. The incentive bonds gains regulated interest % rates over the period of time during the student's educational years, in which the bond policy could be cashed by the student/beneficiary upon proof of completion of Grade School/College level graduation requirements.

In an embodiment, anyone of legal age and with proof of educational enrollment of the beneficiary, can purchase THE APPLETREE GRADUATION PLAN for any beneficiary/student that currently or soon to attend the Basic Grade School or College Level Agency that represents Education & Development requirements of graduation/diploma completion. The purchasers will determine the educational requirements & investment time frame period of the bond. The cash out process before the bond's maturity date will be to the student/beneficiary upon proof of the students diploma.

The Appletree graduation plan (diploma bond), could be purchased from the nine (9) different major bond classes of these open investment markets:

1. TREASURY INVESTMENT BONDS

2. U.S. GOVERNMENT INVESTMENT BONDS

3. CORPORATE INVESTMENT BONDS

4. HIGH-YIELD INVESTMENT BONDS

5. FOREIGN INVESTMENT BONDS

6. MORTGAGE INVESTMENT BONDS

7. CITY, STATE & GOVERNMENT MUNICIPAL INVESTMENT BONDS

8. CONVERTIBLE INVESTMENT BONDS

9. COMMERCIAL INVESTMENT BONDS

For the educational purpose of the student incentive reward upon proof graduation, or other wise the bond's maturity date

The present invention is not a college fund nor college bond. Rather, the present invention is solely for rewarding the child a preexisting educational incentive gift upon showing proof of graduation with a % bond. The new and novel concept of the present business idea is an educational financial account for all ages, a personal financial account (Diploma Bond) payable upon graduation as an incentive gift reward that gain market interest % from the bond company.

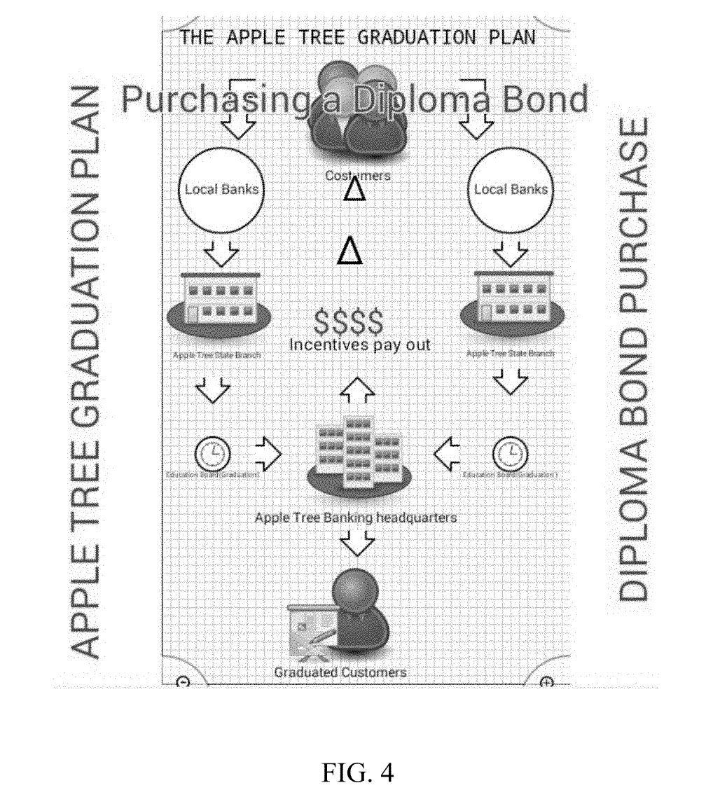

### How to Purchase a Diploma Bond (as Shown in FIG. 4):

The Apple Tree Graduation Plan will be a national commercial company, that will be in partnership with different bank chains, different commercial agencies and other qualified bond issuers agencies. Being that different bank branches will be the most comment ways to purchase diploma bonds and will be an easy step by step process.

1. The customer will easily locate one of many different bank chains we're in partnership with and complete the purchase at one of their branches.

2. The bank will then locate the state Education Board of the customer's choice and file the appropriate documents, then will keep track of the customer's progress through their education term.

3. Then the Education Board will locate THE APPLE TREE GRADUATION PLAN headquarters and show the customers yearly status up infill the graduation date.

4. The Apple Tree Graduation Plan upon receiving proof of graduation from the customer, will then either settle the debt on the Bond maturity date with the graduate.

These are the first easy step by step process on purchasing a Diploma Bond.

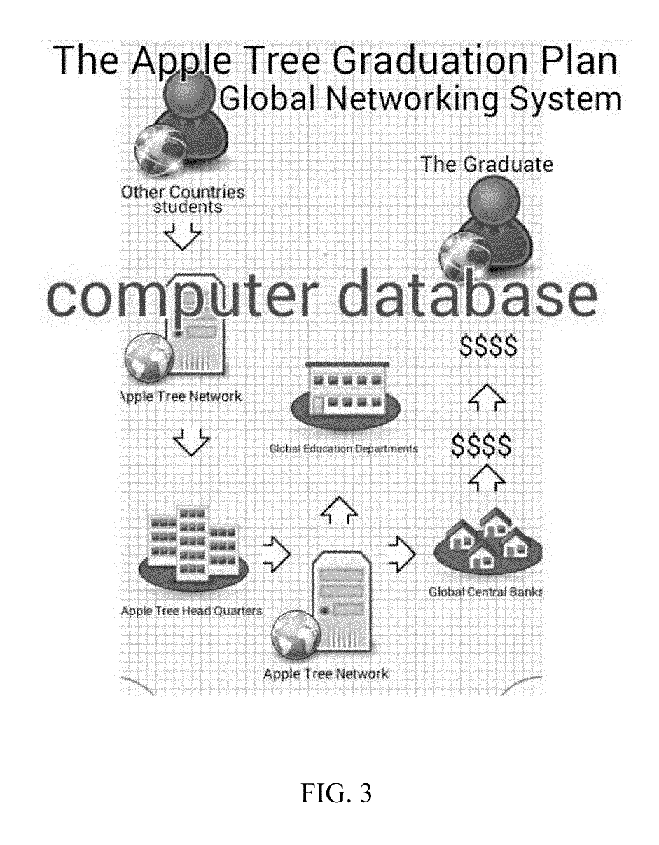

THE APPLE TREE GRADUATION PLAN—GLOBAL NETWORKING SYSTEM (as shown in FIG. 3) is a simple network system that allows customers in other countries to purchase a Diploma Bond online. The customers can go online to THE APPLE TREE GRADUATION PLAN website from anywhere in the world and purchase a Diploma Bond, as long as that customer can prove education enrollment through an Education Department and a Central Bank where funds can be transferred.

(Easy Step by Step Process):

1. The customer goes online to THE APPLE TREE GRADUATION PLAN website and fill out the Bond purchase forms and transfer their funds to purchase a Diploma Bond.

2. The Apple Tree Graduation Plan assigned a foreign Representative that will speak the customer's language and be able to handle all transaction, to verify that all personal contact information is correct.

3. When the maturity date of Bond has arrived, our foreign representative will locate that customer's country education department to see if educational standards has been completed, and start the process to pay out educational incentives to the beneficiary/graduate.

4. Upon approval of educational completion, THE APPLE TREE GRADUATION PLAN Diploma Bond accounting department, will locate the customers' bank of choice and transfer their graduation incentives to them through wire transfer.

5. Then in partnership with the customer's bank of choice THE APPLE TREE GRADUATION PLAN will trust that the trusted bank to verify and deliver incentives to our happy Graduate.

Although the invention has been explained in relation to its preferred embodiment, it is to be understood that many other possible modifications and variations can be made without departing from the spirit and scope of the invention.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A method of increasing account management efficiency comprising the steps of:
a. creating an account, wherein the account is held by a financial institution;
b. establishing a triggering event, wherein the triggering event consists of a graduation date of a predetermined user;
c. distributing the contents of the account based upon the trigger event, wherein the distribution occurs after the triggering event.

2. The method of claim 1, further comprising the step of associating one or more projected dates corresponding to the triggering event, wherein the one or more projected dates are predetermined based on a projected graduation date.

3. The method of claim 2, wherein the account is in communication with a database, wherein the database submits one or more inquiries across one or more networks, wherein the one or more inquiries are based upon the one or more projected dates, and wherein the one or more inquiries are transmitted to a remote server at the user's educational institution.

4. The method of claim 3, wherein the remote database receives the one or more inquiries and cross references the one or more inquiries with an actual graduation date, wherein the actual graduation date is maintained within the remote database.

5. The method of claim 4, wherein the remote database further cross references the one or more inquiries against a list of graduates, wherein if the user is found on the list of graduates, the triggering event occurs.
